(19) United States
(12) Patent Application Publication
(10) Pub. No.: US 2024/0091743 A1
(43) Pub. Date: Mar. 21, 2024

(54) METHODS FOR REACTIVATING PASSIVATED MINERAL RESIDUES

(71) Applicants: CARBONBUILT, INC., EI Segundo, CA (US); THE REGENTS OF THE UNIVERSITY OF CALIFORNIA, Oakland, CA (US)

(72) Inventors: Iman MEHDIPOUR, Los Angeles, CA (US); Gaurav SANT, Los Angeles, CA (US)

(21) Appl. No.: 18/527,079

(22) Filed: Dec. 1, 2023

Related U.S. Application Data
(63) Continuation of application No. PCT/US2022/031843, filed on Jun. 1, 2022.
(60) Provisional application No. 63/196,485, filed on Jun. 3, 2021.

(51) Int. Cl. B01J 20/34; B01J 20/04; B01J 20/30; B01J 20/32; C04B 2/00; C04B 2/02; C04B 28/18; C04B 40/02

(52) U.S. Cl. CPC B01J 20/3475; B01J 20/041; B01J 20/3021; B01J 20/3293; B01J 20/3433; C04B 2/005; C04B 2/02; C04B 28/18; C04B 40/0231

(57) ABSTRACT

The instant disclosure sets forth a process for re-activating a mineral residue. The process includes providing a mineral residue, which includes a core and a shell around the core. In certain examples, the core comprises calcium (Ca), magnesium (Mg), or a combination thereof. The Ca and Mg is not present as elemental Ca or Mg but rather as a compound of Ca or of Mg, such as but not limited to Ca(OH)₂ or Mg(OH)₂. In certain examples, the shell comprises an oxide, a hydroxide, a carbonate, a silicate, a sulfite, a sulfate, a chloride, a nitrate, or nitrite, of calcium (Ca) or of magnesium (Mg), or a combination thereof. The process includes (a) fractionating the mineral residue; (b) contacting the mineral residue with an acid and fractionating the mineral residue; or (c) contacting the mineral residue with a base and fractionating the mineral residue. As a result, the mineral residue's core is exposed. In some examples, the shell is passivating and inhibits the Ca or Mg, or both, in the core from reacting with carbon dioxide (CO₂). By exposing the core as described herein, a mineral residue's reactivity with carbon dioxide is increased.

### CROSS-REFERENCE TO RELATED APPLICATIONS

This application is a continuation application of International Patent Application No. PCT/US2022/031843, filed Jun. 1, 2022, which claims the benefit of, and priority to, U.S. Provisional Patent Application No. 63/196,485, filed Jun. 3, 2021, the entire contents of all of which are herein incorporated by reference in their entirety for all purposes.

### BACKGROUND

Certain minerals (e.g., lime (CaO), portlandite (Ca(OH)₂), etc.) and mineral-based sorbents are effective in reacting with carbon dioxide (CO₂), sulfur trioxide (SO₃), sulfur dioxide (SO₂), nitrogen dioxide (NO₂), nitrogen trioxide (NO₃) and hydrogen chloride (HCl), and other flue gas components and are used to capture them from flue gas streams. For example, when portlandite-based sorbents are used for flue gas treatment (FGT), Ca(OH)₂ reacts with the flue gas components (e.g., CO₂, CO, SOₓ, NOₓ, HCl) to form, e.g., calcium carbonate (CaCO₃), calcium sulfite (CaSO₃), calcium sulfate (CaSO₄), and/or calcium chloride (CaCl₂), among other compounds. Thus, mineral-based sorbent (e.g., lime or portlandite) residues used in FGTs may comprise a mixture of unreacted mineral-based sorbent (e.g., calcium oxide, calcium hydroxide, etc.) and spent (i.e., reacted) sorbent (e.g., comprising calcium sulfates, calcium sulfites, calcium chlorides, calcium nitrate, calcium nitrite, and calcium carbonate compounds, etc.), depending on process type, raw materials, process characteristics, and points of collection. These mineral residues may also vary in terms of particle size (e.g., 500 nm to 5 mm), with particle size distribution ranging from very broad to very narrow, depending on material and process parameters.

Primary types of flue gas desulfurization (FGD) technologies include wet scrubbers, dry scrubbers, and sorbent injection. Wet scrubbers produce a slurry by-product that must be dewatered prior to utilization or disposal, while dry scrubbers produce FGD by-products in the form of dry powders. The desulfurization technology used, along with other FGD process variables, has significant effects on the selection, properties, and compositions of the materials used for FGD, their use, and their disposal. For instance, spray dryers, the most common type of dry scrubber, use small amounts of water to help distribute the alkaline sorbent throughout the flue gas stream, but this water evaporates quickly, leaving behind a dry by-product material. If the dry scrubbing unit is located upstream of the primary particulate control device, then the resulting by-product can include a mixture of fly ash, spent sorbent (e.g., calcium sulfite or sulfate), and the unreacted sorbent (e.g., calcium oxide or calcium hydroxide). Alternatively, if the dry scrubbing unit is located downstream from the primary particulate collection device, then the resulting by-product may include reacted and unreacted sorbent, but no fly ash. Because of the lack of water, however, the by-products are not similar to either flue gas desulphurization gypsum or calcium sulfite sludge.

As one example, portlandite (Ca(OH)₂) is a particularly attractive alkaline mineral sorbent because, in addition to its acidic gas removal efficiency, it can be produced at a substantively lower temperature than ordinary Portland cement (OPC) and can function as a cementation agent upon reacting with a CO₂ gas stream via a CO₂ mineralization reaction. CarbonBuilt's REVERSA™ carbonation process leverages innovations in the use of portlandite, which carbonates readily to produce limestone (CaCO₃)—a potent cementation agent. This approach has been adapted to produce a variety of pre-cast concrete or concrete masonry products having a wide range of geometries, shapes, and performance attributes. Such products have the potential to displace conventional OPC-based products, including traditional OPC-based masonry and precast components.

However, calcium carbonate and/or calcium sulfate form on portlandite particle surfaces in FGT processes. This calcium carbonate and/or calcium sulfate passivates the particle surfaces before the calcium hydroxide core can fully react with flue gas components. Additionally, the agglomerated nature of the portlandite residues further hinders accessibility of flue gases to remaining Ca(OH)₂ (e.g., the unreacted core of portlandite residues). That is, the surface passivation and reduced accessibility to unreacted calcium hydroxide cores within portlandite residues restricts CO₂ gas diffusion through the pores and imposes a self-limited, diffusion-controlled carbonation reaction. Consequently, greater activation energy is required to force CO₂ gas diffusion through the passivation layer formed on partially-used portlandite residues, making the process more energy-intensive and limiting the rate and extent of carbonation reaction. Such effects significantly reduce the performance efficiency of portlandite residues and thus limit the reuse potential of portlandite residues. Similar limitations attend the use of other mineral sorbents (e.g., lime (CaO)) or other industrial residues such as lime kiln dust, cement kiln dust, or coal combustion residues including biomass ashes, fluidized bed combustion ashes, circulating fluidized bed ashes.

Another problem with using industrial mineral residues in concrete is related to the agglomerated nature and high moisture content of the mineral residues. The agglomerates reduce reactivity (hydraulic and pozzolanic) and hinder the accessibility of contacting CO₂-containing gases or water to reactive sites of residues and thereby limit carbonation and hydration reactions.

Against this backdrop, there exists great commercial interest in FGT materials and methods that make more efficient use of sorbent materials (e.g., portlandite and/or lime).

### SUMMARY

In one aspect, the present disclosure relates to a process for re-activating a mineral sorbent residue, comprising: providing a mineral residue, wherein the mineral residue comprises a core and a shell around the core; wherein the core comprises a hydroxide or oxide of calcium (Ca), magnesium (Mg), or a combination thereof; and wherein the shell comprises a member selected from the group consisting of a carbonate, a silicate, a sulfite, a sulfate, a chloride, a nitrate, or nitrite, of calcium (Ca) or of magnesium (Mg), and combinations thereof; and either (a) fractionating the mineral residue; (b) contacting the mineral residue with an acid and fractionating the mineral residue; or (c) contacting the mineral residue with a base and fractionating the mineral residue; to provide reactivated mineral material. In certain examples, the shell optionally includes an oxide or a hydroxide of Ca or of Mg. In some examples, the core is exposed and able to react with CO₂. In certain examples, the core is exposed and the reactivated mineral residue is more reactive with CO₂ than the mineral residue was before step (a), (b), or (c). In some examples, the shell creates a kinetic barrier to the core reacting with CO₂. By removing the shell, partially or completely, the kinetic barrier is reduced or eliminated. In some examples, the shell is a surface coating around the core. In certain examples, the shell passivates the core and prevents the core from reacting with CO₂. When the shell is removed, the core is exposed and can react with CO₂.

In another aspect, the present disclosure relates to a method of treating a mineral residue, comprising: subjecting the mineral residue to fractionation (e.g., particle size reduction and/or deagglomeration); and/or subjecting the mineral residue to mechanochemical treatment comprising a combination of grinding and acid or base treatment, to obtain a reactivated mineral material; wherein the mineral residue comprises at least one of oxides, hydroxides, carbonates, silicates, sulfites, sulfates, chlorides, nitrates, or nitrites of calcium and/or magnesium and/or other uni-/multi-valent elements, or any combination thereof.

In some embodiments, subjecting the mineral residue to fractionation comprises size reduction of particulates using mechanical, acoustic, thermal, or electrical energy. Fractionation, herein, is a process that includes grinding or milling (e.g., ball milling) of materials to reduce the particle sizes of the materials. Fractionation is a process which divides materials into smaller components.

In some embodiments, subjecting the mineral residue to fractionation comprises pre-drying.

In some embodiments, fractionation/grinding the mineral residue comprises at least one of dry grinding, semi-wet grinding, or wet grinding.

In some embodiments, the acid treatment comprises contacting the fractionated/ground sorbent residue with at least one of sulfuric acid, hydrochloric acid, nitric acid, phosphoric acid, phosphorous acid, acetic acid, phosphonic acid, citric acid, myristic acid, glycolic acid, lactic acid, maleic acid, malic acid, succinic acid, glutaric acid, benzoic acid, malonic acid, salicylic acid, gluconic acid, muriatic acid, trifluoroacetic acid, and carbonic acid. In some examples, the acid is sulfuric acid. In some other examples, the acid is hydrochloric acid. In other examples, the acid is nitric acid. In certain other examples, the acid is phosphoric acid. In yet other examples, the acid is phosphorous acid. In some examples, the acid is acetic acid. In certain examples, the acid is phosphonic acid. In other examples, the acid is citric acid. In some other examples, the acid is myristic acid. In other examples, the acid is glycolic acid. In yet other examples, the acid is lactic acid. In some other examples, the acid is maleic acid. In certain other examples, the acid is malic acid. In some other examples, the acid is succinic acid. In some examples, the acid is glutaric acid. In certain examples, the acid is benzoic acid. In some examples, the acid is malonic acid. In some other examples, the acid is salicylic acid. In yet other examples, the acid is gluconic acid. In other examples, the acid is muriatic acid. In some examples, the acid is trifluoroacetic acid. In some other examples, the acid is carbonic acid.

In some embodiments, the base treatment comprises contacting the fractionated/ground sorbent residue with at least one of sodium hydroxide, potassium hydroxide, lithium hydroxide, calcium hydroxide, magnesium hydroxide, ammonium hydroxide, sodium carbonate, sodium bicarbonate, ammonia, methylamine, dimethylamine, trimethylamine, triethylamine, monoethanolamine, diethanolamine, triethanolamine, isopropanolamine, diisopropanolamine, triisopropanolamine, alkali metal silicates, and alkaline earth metal silicates.

In some embodiments, subjecting a sorbent residue to mechanochemical treatment (comprising a combination of grinding and acid or base treatment) further comprises drying the residue. In some embodiments, the mineral residue may be subjected to drying before, during, or after the reactivation treatment comprising: subjecting the mineral residue to fractionation (e.g., particle size reduction and/or deagglomeration); and/or subjecting the mineral residue to mechanochemical treatment comprising a combination of grinding and acid or base treatment, to obtain a reactivated mineral material; wherein the mineral residue comprises at least one of oxides, hydroxides, carbonates, silicates, sulfites, sulfates, chlorides, nitrates, or nitrites of calcium and/or magnesium and/or other uni-/multi-valent elements, or any combination thereof.

In some embodiments, the mineral residue comprises, consists essentially of, or consists of CaO and/or Ca(OH)₂.

In some embodiments, the mineral residue is obtained by contacting a mineral sorbent with a carbon dioxide-containing gas stream (e.g., a flue gas) via scrubbing or sorbent injection (dry or semi-wet) methods. In some embodiments, the mineral residue is obtained by contacting a mineral sorbent with an atmospheric carbon dioxide source. Thermogravimetric analysis (TGA) or x-ray diffraction (XRD) may be used to determine the chemical composition of the residue. By knowing the chemical composition, e.g., presence of CaCO₃, CaSO₄, CaCl, or other species, one can determine the process from which the sorbent residue was made.

In some embodiments, the method further comprises using the reactivated mineral material for soil stabilization, waste stabilization, neutralizing acid-forming materials, or forming concrete mixtures.

In some embodiments, the method further comprises adding the reactivated mineral material to form a concrete slurry.

In some embodiments, the mineral residue has an average particle size of less than 5 mm. In some embodiments, the mineral residue has an average particle size of at least about 500 μm. In some embodiments, the reactivated mineral material has an average particle size of at least about 100 μm. In some embodiments, the reactivated mineral material has an average particle size of less than about 500 nm. In some embodiments, the reactivated mineral material has an average particle size of less than about 100 nm.

In some embodiments, the mineral residue has an average particle size of greater than about 5 mm. In some embodiments, the mineral residue has an average particle size of greater than about 500 μm. In some embodiments, the reactivated mineral material has an average particle size of greater than about 100 μm. In some embodiments, the reactivated mineral material has an average particle size of greater than about 500 nm. In some embodiments, the reactivated mineral material has an average particle size of greater than about 100 nm.

In some embodiments, the mineral residue comprises CaO and/or Ca(OH)₂.

In another aspect, which may be combined with any other aspect or embodiment, the present disclosure relates to a process for re-activating a mineral residue, comprising: providing a mineral residue, wherein the mineral residue comprises a core and a shell around the core; wherein the core comprises calcium (Ca), magnesium (Mg), or a combination thereof; and wherein the shell comprises a member selected from the group consisting of an oxide, a hydroxide, a carbonate, a silicate, a sulfite, a sulfate, a chloride, a nitrate, or nitrite, of Ca or of magnesium (Mg), and combinations thereof; and either (a) fractionating the mineral residue; (b) contacting the mineral residue with an acid and fractionating the mineral residue; or (c) contacting the mineral residue with a base and fractionating the mineral residue; to provide a mineral residue wherein the core is exposed.

In another aspect, which may be combined with any other aspect or embodiment, the present disclosure relates to a process for re-activating a mineral residue, comprising: providing a mineral residue, wherein the mineral residue comprises a core and a shell around the core; wherein the core comprises calcium (Ca), magnesium (Mg), or a combination thereof; and wherein the shell comprises a member selected from the group consisting of a carbonate, a silicate, a sulfite, a sulfate, a chloride, a nitrate, or nitrite, of Ca or of magnesium (Mg), and a combination thereof; and either (a) fractionating the mineral residue; (b) contacting the mineral residue with an acid and fractionating the mineral residue; or (c) contacting the mineral residue with a base and fractionating the mineral residue; to provide a reactivated mineral residue wherein the core is exposed. In some examples, the reactivated mineral residue is more reactive with CO₂, H₂O, and/or cementitious reactions than the mineral residue from which the reactivated mineral residue was made.

In another aspect, which may be combined with any other aspect or embodiment, the present disclosure relates to a process for re-activating a mineral residue, comprising: providing a mineral residue, wherein the mineral residue comprises a core and a shell around the core; wherein the core comprises calcium (Ca), magnesium (Mg), or a combination thereof; and wherein the shell comprises a member selected from the group consisting of a carbonate, a silicate, a sulfite, a sulfate, a chloride, a nitrate, or nitrite, of Ca or of magnesium (Mg), and combinations thereof; and either (a) fractionating the mineral residue; (b) contacting the mineral residue with an acid and fractionating the mineral residue; or (c) contacting the mineral residue with a base and fractionating the mineral residue; to provide a reactivated mineral residue.

In some examples, including any of the foregoing, the core comprises Ca(OH)₂ or Mg(OH)₂ or a combination thereof.

In some examples, including any of the foregoing, the core comprises Ca(OH)₂.

In some examples, including any of the foregoing, the core comprises Mg(OH)₂.

In some examples, including any of the foregoing, the core comprises Ca(OH)₂ and Mg(OH)₂.

In some examples, including any of the foregoing, the shell comprises a carbonate of Ca, a carbonate of Mg, or a combination thereof.

In some examples, including any of the foregoing, the shell comprises CaCO₃.

In some examples, including any of the foregoing, the mineral residue is obtained by contacting a mineral sorbent with a flue gas.

In some examples, including any of the foregoing, the mineral residue was used in a scrubbing or sorbent injection (dry or semi-wet) method.

In some examples, including any of the foregoing, the mineral residue is obtained from hydrated lime that was previously used in a flue gas treatment process which used the sorbent injection method.

In some examples, including any of the foregoing, the mineral residue is an alkaline-rich mineral material which has been already contacted with CO₂-containing gas stream.

In some examples, including any of the foregoing, the mineral residue is collected from an industrial process such as lime kiln dust, cement kiln dust, fly ash, limestone, and combinations thereof.

In some examples, including any of the foregoing, the mineral residue is collected from an industrial process such as lime kiln dust, cement kiln dust, coal combustion residues, off-spec ashes, ponded ashes, landfilled ashes, and bottom ashes, biomass ashes, fluidized bed combustion ashes, circulating fluidized bed ashes, flue gas ashes, limestone, slag (e.g., basic oxygen furnace slag, electric arc furnace slag, ladle slag, or blast furnace slag) and combinations thereof.

In some examples, including any of the foregoing, the mineral residue is selected from the group consisting of hydrated lime, lime kiln dust, cement kiln dust, fly ash, limestone, and combinations thereof.

In some embodiments, mineral residue is collected from industrial solid wastes including coal combustion residues (e.g., class C fly ash, class F fly ashes), ponded ashes, landfilled ashes, and bottom ashes, biomass ashes, fluidized bed combustion ashes, circulating fluidized bed ashes, flue gas ashes, flue gas gypsum, cement kiln dust, and slag (e.g., basic oxygen furnace slag, electric arc furnace slag, ladle slag, or blast furnace slag).

In some examples, including any of the foregoing, the shell partially surrounds the core prior to steps (a), (b), and (c).

In some examples, including any of the foregoing, the shell completely surrounds the core prior to steps (a), (b), and (c).

In some examples, including any of the foregoing, the shell does not surround or partially surrounds the core after step (a), (b), or (c).

In some examples, including any of the foregoing, the core is exposed after step (a), (b), or (c).

In some examples, including any of the foregoing, the mineral residue has a higher specific surface-area after steps (a), (b), or (c).

In some examples, including any of the foregoing, the mineral residue has a specific surface-area at least 10% higher after steps (a), (b), or (c).

In some examples, including any of the foregoing, the mineral residue has a specific surface-area at least 20% higher after steps (a), (b), or (c).

In some examples, including any of the foregoing, the mineral residue has a specific surface-area before steps (a), (b), or (c) that is lower than mineral residue.

In some examples, including any of the foregoing, the mineral residue has a specific surface-area of 230 m²/kg or less before steps (a), (b), or (c).

In some examples, including any of the foregoing, the mineral residue has a specific surface-area of 230 m²/kg or more after steps (a), (b), or (c).

In some examples, including any of the foregoing, the process includes (a) fractionating the mineral residue if the amount of carbonate in the mineral residue is twenty percent to fifty percent by weight.

In some examples, including any of the foregoing, the (a) fractionating the mineral residue if the amount of carbonate in the mineral residue is fifty percent or less by weight.

In some examples, including any of the foregoing, the ratio of Ca(OH)₂/CaCO₃ in the mineral residue increases after steps (a), (b), or (c).

In some examples, including any of the foregoing, the ratio of Ca(OH)₂/CaCO₃ in the mineral residue increases at least 20% after steps (a), (b), or (c).

In some examples, including any of the foregoing, the ratio of Ca(OH)₂/CaCO₃ in the mineral residue increases up to 50% after steps (a), (b), or (c).

In some examples, including any of the foregoing, the ratio of CaSO₄/CaCO₃ in the mineral residue increases after steps (a), (b), or (c).

In some examples, including any of the foregoing, the ratio of CaSO₄/CaCO₃ in the mineral residue increases at least 20% after steps (a), (b), or (c).

In some examples, including any of the foregoing, the ratio of CaSO₄/CaCO₃ in the mineral residue increases up to 50% after steps (a), (b), or (c).

In some examples, including any of the foregoing, the ratio of Ca(OH)₂/CaSO₄ in the mineral residue increases after steps (a), (b), or (c).

In some examples, including any of the foregoing, the ratio of Ca(OH)₂/CaSO₄ in the mineral residue increases at least 20% after steps (a), (b), or (c).

In some examples, including any of the foregoing, the ratio of Ca(OH)₂/CaSO₄ in the mineral residue increases up to 50% after steps (a), (b), or (c).

In some examples, including any of the foregoing, the mineral residue has a specific surface-area of 230 m²/g or less before steps (a), (b), or (c).

In some examples, including any of the foregoing, the mineral residue has a specific surface-area of 230 m²/g or more after steps (a), (b), or (c).

In some examples, the SSA increases because the acid dissolves a passivating layer of CaCO₃.

In some examples, the SSA increases because the fractionating removes the passivating layer of CaCO₃.

In some examples, the SSA increases because both the acid dissolves a passivating layer of CaCO₃ and the fractionating removes the passivating layer of CaCO₃.

In some examples, including any of the foregoing, the process includes (a) fractionating the mineral residue if the amount of carbonate in the mineral residue is fifty percent or less by weight.

In some examples, including any of the foregoing, the process includes either (b) contacting the mineral residue with an acid and fractionating the mineral residue; or (c) contacting the mineral residue with a base and fractionating the mineral residue; if the amount of carbonate in the mineral residue is fifty percent or more by weight.

In some examples, including any of the foregoing, the process includes contacting the mineral residue with an acid and fractionating the mineral residue.

In some examples, including any of the foregoing, fractionating the mineral residue comprises grinding the mineral residue.

In some examples, including any of the foregoing, fractionating the mineral residue comprises milling the mineral residue.

In some examples, including any of the foregoing, the milling is selected from the group consisting of high-energy milling, ball milling, wet milling, dry milling, and jet milling.

In some examples, including any of the foregoing, the ball milling is at 200 RPM or greater.

In some examples, including any of the foregoing, the ball milling is with steel ball media. In some examples, the steel ball media has a ball diameter of 1 mm to 25 mm.

In some examples, including any of the foregoing, the mineral residue is provided as particulates; and fractionating the mineral residue comprises size reduction of the particulates using mechanical-, acoustic-, thermal-, electrical-energy, or a combination thereof.

In some examples, including any of the foregoing, the mineral residue is provided as particulates; and fractionating the mineral residue comprises increasing the specific surface area of the particulates using mechanical, acoustic, thermal, electrical energy, or a combination thereof.

In some examples, including any of the foregoing, fractionating the mineral residue comprises at least one of dry grinding, semi-wet grinding, or wet grinding.

In some examples, including any of the foregoing, the acid is selected from the group consisting of sulfuric acid, hydrochloric acid, nitric acid, phosphoric acid, phosphorous acid, acetic acid, phosphonic acid, citric acid, myristic acid, glycolic acid, lactic acid, maleic acid, malic acid, succinic acid, glutaric acid, benzoic acid, malonic acid, salicylic acid, gluconic acid, muriatic acid, trifluoroacetic acid, carbonic acid, and combinations thereof.

In some examples, including any of the foregoing, the process includes contacting the mineral residue with acid during the fractionating.

In some examples, including any of the foregoing, the process includes contacting the mineral residue with acid after the fractionating.

In some examples, including any of the foregoing, the process includes contacting the mineral residue with acid before the fractionating.

In some examples, including any of the foregoing, the acid is nitric acid. In some examples, the acid has an acid concentration from 0.001 M to 1 M. In yet other examples, the acid has an acid concentration is from 0.01 M to 1 M.

In some examples, including any of the foregoing, the acid is nitric acid. In some examples, the acid has an acid concentration from about 0.001 M to about 1 M. In yet other examples, the acid has an acid concentration is from about 0.01 M to about 1 M.

In some examples, including any of the foregoing, the base is selected from the group consisting of sodium hydroxide, potassium hydroxide, lithium hydroxide, calcium hydroxide, magnesium hydroxide, ammonium hydroxide, sodium carbonate, sodium bicarbonate, ammonia, trimethylamine, triethylamine, monoethanolamine, diethanolamine, triethanolamine, isopropanolamine, diisopropanolamine, triisopropanolamine, alkali metal silicates, alkaline earth metal silicates, and combinations thereof.

In some examples, including any of the foregoing, the process includes contacting the mineral residue with base during the fractionating.

In some examples, including any of the foregoing, the process includes contacting the mineral residue with base after the fractionating.

In some examples, including any of the foregoing, the process includes contacting the mineral residue with base before the fractionating.

In some examples, including any of the foregoing, the mineral residues have an average particle size of less than 5 mm.

In some examples, including any of the foregoing, the mineral residues have particle size distribution as shown in any one of FIG. 2a or 7.

In some examples, including any of the foregoing, the process includes generating a reactivated mineral material.

In some examples, including any of the foregoing, the process includes using the reactivated mineral material for soil stabilization, waste stabilization, neutralizing acid-forming materials, or forming concrete mixtures.

In some examples, including any of the foregoing, the process includes adding the reactivated mineral material to form a concrete slurry.

In another aspect, which may be combined with any other aspect or embodiment, the present disclosure relates to a method of forming a concrete component comprising: forming a cementitious slurry comprising aggregates and a reactivated mineral material obtained from a mineral residue that has been subjected to at least one of (i) fractionation and (ii) mechanochemical treatment comprising a combination of grinding and acid or base treatment to obtain the reactivated mineral material; shaping the cementitious slurry into a structural component; and exposing the structural component to carbon dioxide sourced from CO₂ emission sources (e.g., industrial CO₂-containing gas stream, dilute flue gas stream, a concentrated CO₂ gas stream), or from the atmosphere, thereby forming the concrete component.

In some embodiments, the cementitious slurry further comprises a second mineral material that has not been subjected to the at least one of (i) fractionation and (ii) mechanochemical treatment comprising combined grinding with acid or base treatment used to obtain the reactivated mineral material.

In some embodiments, the shaping comprises casting, extruding, molding, pressing, or 3D-printing of the cementitious slurry.

In another aspect, which may be combined with any other aspect or embodiment, the present disclosure relates to a concrete product produced by incorporating the reactivated mineral material into a cementitious slurry.

In another aspect, which may be combined with any other aspect or embodiment, the present disclosure relates to a concrete product produced by any of the above-discussed methods.

In another aspect, which may be combined with any other aspect or embodiment, the present disclosure relates to a method of stabilizing compounds comprising sulfates, sulfites, and/or chlorides in sorbent residues, the method comprising: exposing a composition comprising the reactivated mineral material into a cementitious slurry and exposing the resulting cementitious slurry to CO₂.

In another aspect, which may be combined with any other aspect or embodiment, the present disclosure relates to a reactivated mineral material obtained by any of the above-discussed methods.

### BRIEF DESCRIPTIONS OF THE DRAWINGS

FIG. 1A shows a plot of specific surface-area (SSA) as a function of milling duration (hours) from Example 1.

FIG. 1B shows a plot of SSA as a function of milling media ball-to-powder weight ratio from Example 1.

FIG. 2A shows a particle size distribution plot of cumulative % of particles as a function of Particle Size in microns (1 μm).

FIG. 2B shows a plot of SSA as a function of milling duration (hours).

FIG. 3 shows a plot of the weight ratio of Ca(OH)₂:CaCO₃ for five mineral residues in Example 3.

FIG. 4 shows a plot of the ratio (gCO₂/g mineral) of the net carbon dioxide (CO₂) uptake relative to the amount of mineral residue for five mineral residues in Example 4.

FIG. 5 shows a plot of the ratio (gCO₂/g mineral) of the net carbon dioxide (CO₂) uptake relative to the amount of mineral residue as a function of the weight ratio of Ca(OH)₂:CaCO₃ for four mineral residues in Example 4.

FIG. 6 shows the 28-day compressive strength of carbonated concretes made in Example 5.

FIG. 7 shows a particle size distribution plot of cumulative % of particles as a function of Particle Size in microns (μm).

### DETAILED DESCRIPTION

### Definitions

As used herein, the singular terms “a,” “an,” and “the” include plural referents unless the context clearly dictates otherwise. Thus, for example, reference to an object can include multiple objects unless the context clearly dictates otherwise.

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, the term “size” refers to a characteristic dimension of an object. Thus, for example, a size of an object that is circular can refer to a diameter of the object. In the case of an object that is non-circular, a size of the non-circular object can refer to a diameter of a corresponding circular object, where the corresponding circular object exhibits or has a particular set of derivable or measurable characteristics that are substantially the same as those of the non-circular object. Alternatively, or in conjunction, a size of a non-circular object can refer to an average of various orthogonal dimensions of the object. Thus, for example, a size of an object that is an ellipse can refer to an average of a major axis and a minor axis of the object. When referring to a set of objects as having a particular size, it is contemplated that the objects can have a distribution of sizes around the particular size. Thus, as used herein, a size of objects in a set of objects can refer to a typical size or a distribution of sizes, such as an average size, a median size, or a peak size.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

As used herein, the term, “treating,” refers to a process by which a mineral residue is chemically modified by reaction with an acid or base, or a combination thereof.

As used herein, the term, “mechanochemical treatment,” refers to a process that includes mechanical inputs of energy (e.g., ball milling) and also includes using an acid or base which reacts with a mineral residue. In some examples, the acid or base removes a passivating layer or shell from a mineral residue to thereby expose the core of the mineral residue. By exposing the core, the exposed core can react with CO₂. In some examples, milling removes a passivating layer or shell from a mineral residue to thereby expose the core of the mineral residue. The passivating layer or shell may be continuous or discontinuous. Milling may also increase the specific surface-area of the mineral residue. By fractionating, acid treating, base treating, or a combination thereof, the mineral residues may be re-activated for reactivity with CO₂. This occurs by removing a passivating layer or passivating shell thereby exposing a core of Ca which can react with CO₂.

As used herein a “mineral residue” may include hydrated lime, lime kiln dust, cement kiln dust, fly ash, limestone, slag, or combinations thereof. A mineral residue also includes alkaline-rich mineral material (defined below).

As used herein, the term, “mineral sorbent residue,” refers to a mineral residue which has been used, for example, in concrete production; or in a flue gas treatment, for example, as a sorbent or scrubbing materials that are used for flue gas treatment or byproducts that are generated during industrial processes such as cement and lime manufacturing, and power generating plants. A residue may be referred to in the art as a mineral sorbent. A “residue” may be an alkaline-rich mineral material (defined below) which has previously been contacted with a CO₂-containing gas stream, for example, as a sorbent or scrubber in a CO₂-flue gas treatment process or it can be an aluminosilicate mineral material that has been obtained as solid waste through an industrial process such as coal combustion residues. An alkaline-rich residue may include hydrated lime, lime kiln dust, off-spec limes, or a combination thereof. An aluminosilicate residue may include coal combustion residues, slag, off-spec fly ashes, biomass ashes, fluidized bed combustion ashes, circulating fluidized bed ashes, calcium rich fly ashes, calcium-poor fly ashes, ponded ashes, landfilled ashes, bottom ashes, flue gas ashes, and combinations thereof. As used herein, the term, “fractionation,” “fractionating,” or “grinding,” refers to a process by which a mineral is broken down into smaller particles or particles with a high surface area. Fractionating may be accomplished by a variety of processes. One non-limiting example of a fractionating process is ball milling.

As used herein, the term, “deagglomeration,” refers to a process by which a collection of particles are separated into individual particles and optionally wherein those particles are broken down into smaller particles or particles with a high surface area.

As used herein, the term, “reactivated mineral material,” or “re-activated mineral material,” refers to a mineral residue that had a passivating surface layer or passivating shell removed by a process described herein so that the core of the mineral residue is exposed. In some examples, the core is exposed and is able to react with CO₂. In some examples, the core is exposed and is able to react with CO₂ and H₂O. In some examples, the core is exposed and is able to react with CO₂ or H₂O. In some examples, the core is exposed and is reactive and offers cementitious properties. Herein, the reactivated mineral material is more reactive than the mineral residue from which the reactivated mineral material was made.

Oxides, hydroxides, carbonates, silicates, sulfites, sulfates, chlorides, nitrates, or nitrites of calcium and/or magnesium refer to chemical compounds that include either Ca, Mg, or both, and which are also classified as oxides, hydroxides, carbonates, silicates, sulfites, sulfates, chlorides, nitrates, or nitrites. Non-limiting examples include CaO, CaCO₃, CaSO₄, and CaNO₃.

As used herein, “alkaline-rich mineral materials” refers to materials which include Ca and/or Mg. Alkaline-rich mineral materials include, but are not limited to, Ca(OH)₂, lime kiln dust, lime, hydrated lime, cement kiln dust, calcium-rich coal combustion residues, slag, off-spec fly ashes, biomass ashes, fluidized bed combustion ashes, circulating fluidized bed ashes, off-spec limes, mineral sorbent/scrubbing residues comprising anhydrous CaO and/or Ca(OH)₂, and combinations thereof. The alkaline-rich mineral materials may further comprise at least one of oxides, hydroxides, carbonates, silicates, sulfites, sulfates, chlorides, nitrates, or nitrites of calcium and/or magnesium, or any combination thereof.

As used herein, the term “CO₂-containing gas stream,” refers to a gas stream effluent from a source which includes carbon dioxide (CO₂) such as CO₂-containing gas stream, dilute flue gas stream, a concentrated CO₂ gas stream, biomass-derived CO₂ or atmospherically derived CO₂.

As used herein, the term “a carbonated concrete composite,” refers to a carbonated concrete object (e.g., a building material) made from early-age (e.g., fresh) concrete that is then contacted with a CO₂-containing curing gas having a suitable CO₂ concentration.

As used herein, the term “material performance of a carbonated concrete composite” refers to a characteristic of the composite such as porosity, compressibility, and/or other mechanical or strength measurement (e.g., Young's modulus, yield strength, ultimate strength, fracture point, etc.).

Embodiments of the present disclosure include methods for treating and reactivating mineral sorbent (e.g., portlandite (Ca(OH)₂)) residues that are partially reacted after use in flue gas treatment processes (e.g., via scrubbing technologies or sorbent injection (dry or semi-wet) methods). In some embodiments, the treatment methods include: (i) fractionation and/or (ii) mechanochemical treatment including a combination of grinding and acid or base treatment. The treated mineral sorbent (e.g., portlandite) residue is thereby “reactivated” in that the surfaces of the mineral residue or mineral sorbent residue previously passivated by reaction with a gas stream (e.g., a flue gas including carbon dioxide, NOₓ, SOₓ, hydrochloric acid, etc.) are either removed, or the underlying “active” moieties (e.g., Ca(OH)₂) is exposed. The reactivated mineral material has the potential to be utilized, e.g., for engineering applications such as soil and waste stabilization, neutralizing acid-forming materials, and in concrete formulations. In some embodiments, the methods of the present disclosure utilize treated CaO and/or portlandite (Ca(OH)₂) residues in the form of dry or wet particulates or as a slurry in concrete to produce stable mineral carbonates via a mineral carbonation process.

No utilization data are available for recycled portlandite residues and general disposal practices are placement of residues in waste piles or in land- or quarry fills. By way of non-limiting example, the present disclosure provides treatment methods for removal of a passivation layer and reactivating the remaining CaO/Ca(OH)₂ in FGT-residues through (1) fractionation including deagglomeration/grinding and/or (2) mechanochemical treatment via a combination of grinding with acid or base treatment. Other combinations of treatments are of course possible, using a wide variety of mineral residues, mineral sorbents or mineral sorbent residues.

In some embodiments, the mineral residue comprises at least one of oxides, hydroxides, carbonates, silicates, sulfites, sulfates, chlorides, nitrates, or nitrites of calcium and/or magnesium and/or other uni-/multi-valent elements or any combination thereof. In some embodiments, the mineral residue comprises, consists essentially of, or consists of anhydrous CaO and/or Ca(OH)₂.

The methods of treating mineral residues may comprise, consist essentially of, or consist of any suitable methods for exposing unreacted mineral materials (e.g., Ca(OH)₂) and/or removing a passivation layer on the surfaces of mineral residue particles that is unable to react with a gas stream (e.g., flue gas stream). In some embodiments, the methods comprise fractionation and/or subjecting the residue to mechanochemical treatment comprising any combination of grinding, and acid and/or base treatment to obtain a reactivated (e.g., non-passivated) mineral material. In some embodiments, subjecting the sorbent to fractionation comprises size reduction of particulates using mechanical, acoustic, thermal or electrical energy. In some embodiments, grinding the mineral residues comprises drying, semi-wet, or wet grinding. In some embodiments, this may include a drying step.

In some embodiments, the mineral residue particles may be contacted with any suitable acid or combination of acids for removing a passivation layer on the surfaces of the mineral residue particles that is unable to react with a gas stream (e.g., flue gas stream). In some embodiments, the acid may comprise, consist essentially of, or consist of at least one of sulfuric acid, hydrochloric acid, nitric acid, phosphoric acid, phosphorous acid, acetic acid, phosphonic acid, citric acid, myristic acid, glycolic acid, lactic acid, maleic acid, malic acid, succinic acid, glutaric acid, benzoic acid, malonic acid, salicylic acid, gluconic acid, muriatic acid, trifluoroacetic acid, and carbonic acid. In some embodiments, the acid is sprayed onto the mineral residues to dissolve a passivation layer (e.g., comprising carbonate, sulfate, sulfite, chloride, etc., precipitates) on the particle surfaces or inside the pores of the mineral residue particles. In some embodiments, this may include a drying step.

In some embodiments, the mineral residue particles may be contacted with any suitable base or combination of bases for removing a passivation layer on the surfaces of the mineral residue particles that is unable to react with a gas stream (e.g., flue gas stream). In some embodiments, the base may comprise, consist essentially of, or consist of at least one of sodium hydroxide, potassium hydroxide, lithium hydroxide, calcium hydroxide, magnesium hydroxide, ammonium hydroxide, sodium carbonate, sodium bicarbonate, ammonia, trimethylamine, trimethylamine, monoethanolamine, diethanolamine, triethanolamine, isopropanolamine, diisopropanolamine, triisopropanolamine, alkali metal silicates, and alkaline earth metal silicates. In some embodiments, this may include a drying step.

In some embodiments, the mineral residues may have an average particle size of at least about 500 nm, at least about 600 nm, at least about 700 nm, at least about 800 nm, at least about 900 nm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, or greater, or any range or value therebetween.

In some embodiments, the mineral residues may have an average particle size of less than or equal to about 5 mm, less than or equal to about 4 mm, less than or equal to about 3 mm, less than or equal to about 2 mm, less than or equal to about 1 mm, less than or equal to about 900 μm, less than or equal to about 800 μm, less than or equal to about 700 μm, less than or equal to about 600 μm, less than or equal to about 500 μm, less than or equal to about 400 μm, less than or equal to about 300 μm, less than or equal to about 200 μm, less than or equal to about 100 μm, less than or equal to about 90 μm, less than or equal to about 80 μm, less than or equal to about 70 μm, less than or equal to about 60 μm, less than or equal to about 50 μm, less than or equal to about 40 μm, less than or equal to about 30 μm, less than or equal to about 20 μm, less than or equal to about 10 μm, less than or equal to about 9 μm, less than or equal to about 8 μm, less than or equal to about 7 μm, less than or equal to about 6 μm, less than or equal to about 5 μm, less than or equal to about 4 μm, less than or equal to about 3 μm, less than or equal to about 2 μm, less than or equal to about 1 μm, less than or equal to about 900 nm, less than or equal to about 800 nm, less than or equal to about 700 nm, less than or equal to about 600 nm, less than or equal to about 500 nm, or less, or any range or value therebetween.

In some embodiments, the mineral residues may have an average particle size of about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, or any range or value therebetween

In some embodiments, the mineral residues may have an average particle size of between about 500 nm and about 5 mm, between about 500 nm and about 1 mm, between about 500 nm and about 500 μm, or between about 500 nm and about 100 μm, or any range or value therein.

In some embodiments, the reactivated mineral material may have an increased fineness (or smaller average particle size) compared to the mineral residue particles, permitting faster or more complete flue gas uptake (e.g., CO₂ uptake) when compared to mineral residues. In some embodiments, the reactivated mineral material may have an average particle size of at least about 500 nm, at least about 600 nm, at least about 700 nm, at least about 800 nm, at least about 900 nm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, or greater, or any range or value therebetween.

In some embodiments, the reactivated mineral material may have an average particle size of less than or equal to about 5 mm, less than or equal to about 4 mm, less than or equal to about 3 mm, less than or equal to about 2 mm, less than or equal to about 1 mm, less than or equal to about 900 μm, less than or equal to about 800 μm, less than or equal to about 700 μm, less than or equal to about 600 μm, less than or equal to about 500 μm, less than or equal to about 400 μm, less than or equal to about 300 μm, less than or equal to about 200 μm, less than or equal to about 100 μm, less than or equal to about 90 μm, less than or equal to about 80 μm, less than or equal to about 70 μm, less than or equal to about 60 μm, less than or equal to about 50 μm, less than or equal to about 40 μm, less than or equal to about 30 μm, less than or equal to about 20 μm, less than or equal to about 10 μm, less than or equal to about 9 μm, less than or equal to about 8 μm, less than or equal to about 7 μm, less than or equal to about 6 μm, less than or equal to about 5 μm, less than or equal to about 4 μm, less than or equal to about 3 μm, less than or equal to about 2 μm, less than or equal to about 1 μm, less than or equal to about 900 nm, less than or equal to about 800 nm, less than or equal to about 700 nm, less than or equal to about 600 nm, less than or equal to about 500 nm, or less, or any range or value therebetween.

In some embodiments, the reactivated mineral material may have an average particle size of about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, or any range or value therebetween.

In some embodiments, the reactivated mineral material may have an average particle size of between about 500 nm and about 5 mm, between about 500 nm and about 1 mm, between about 500 nm and about 500 μm, or between about 500 nm and about 100 μm, or any range or value therein.

By way of non-limiting example, treated mineral residues (e.g., portlandite) can be utilized in concrete, where they may be converted into stable carbonate minerals via carbonation reaction (reaction between treated mineral residues with CO₂ gas streams in concrete). The precipitation of solid carbonate minerals can also help to stabilize other impurities (e.g., sulfates and chlorides) of mineral sorbent residues (e.g., portlandite) in concrete by reducing their dissolution and leaching.

In some embodiments, the mineral sorbent residue is obtained by contacting a mineral sorbent material (e.g., portlandite) with a flue gas (e.g., from an industrial source such as a coal-fired power plant) to treat the flue gas via scrubbing or sorbent injection (e.g., dry or semi-wet) methods. In some embodiments, the method further comprises using the reactivated (e.g., non-passivated) mineral material for soil and/or waste stabilization, neutralizing acid-forming materials, or forming concrete mixtures. In some embodiments, the method further comprises adding the reactivated/non-passivated mineral material to form a concrete slurry.

Additional embodiments include a method of forming a concrete component comprising: forming a cementitious slurry comprising aggregates and a reactivated mineral material (e.g., reactivated portlandite) obtained from a mineral sorbent residue (e.g., passivated portlandite residues) that has previously been subjected to either fractionation and/or mechanochemical treatment comprising grinding and acid or base treatment to obtain the reactivated mineral material (e.g., portlandite); shaping the cementitious slurry into a structural component; and exposing the structural component to carbon dioxide emission source such as dilute flue gas stream and concentrated CO₂ gas streams, or the atmosphere thereby forming the concrete product. In some embodiments, the shaping comprises casting, extruding, molding, pressing, or 3D-printing of the cementitious slurry.

In some examples, including any of the foregoing, the process includes (a) fractionating the mineral residue if the amount of carbonate in the mineral residue is twenty percent to fifty percent by weight.

In some examples, including any of the foregoing, the process includes (a) fractionating the mineral residue if the amount of carbonate in the mineral residue is fifty percent or less by weight.

In some examples, including any of the foregoing, the ratio of Ca(OH)₂/CaCO₃ in the mineral residue increases after step (a), (b), or (c).

In some examples, including any of the foregoing, the ratio of Ca(OH)₂/CaCO₃ in the mineral residue increases at least 20% after step (a), (b), or (c).

In some examples, including any of the foregoing, the ratio of Ca(OH)₂/CaCO₃ in the mineral residue increases up to 50% after step (a), (b), or (c).

In some examples, including any of the foregoing, the process includes either (b) contacting the mineral residue with an acid and fractionating the mineral residue; or (c) contacting the mineral residue with a base and fractionating the mineral residue; if the amount of carbonate in the mineral residue is twenty percent or more by weight.

In some examples, including any of the foregoing, the process includes either (b) contacting the mineral residue with an acid and fractionating the mineral residue; or (c) contacting the mineral residue with a base and fractionating the mineral residue; if the amount of carbonate in the mineral residue is fifty percent or more by weight.

In some examples, including any of the foregoing, the mineral residue is a mineral sorbent residue

In some examples, including any of the foregoing, the mineral residue is cement kiln dust, lime kiln dust, fly ashes, or combinations thereof.

In some embodiments, the cementitious slurry further comprises a second mineral material (e.g., unreacted portlandite) that may or may not have been subjected to the treatment(s) discussed above to obtain the reactivated mineral material. In some embodiments, the cementitious slurry comprises a combination of a new mineral material and a reactivated mineral material.

Additional embodiments include a concrete product produced by incorporating the reactivated/non-passivated mineral material of any of the above embodiments into a cementitious slurry. Additional embodiments include a concrete product produced by a method of any of the above embodiments. Additional embodiments include a method of stabilizing compounds comprising sulfates and/or chlorides in portlandite residues, comprising exposing a composition comprising the reactivated/non-passivated mineral material of any of the above embodiments into a cementitious slurry and exposing the resulting cementitious slurry to CO₂.

### EXAMPLES

### Example 1

### Effects of Fractionation Parameters on Enhancing Surface Areas of Mineral Residues

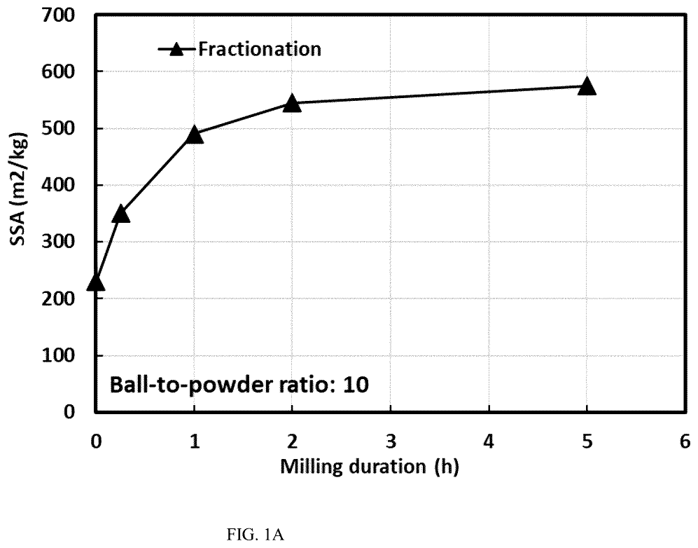

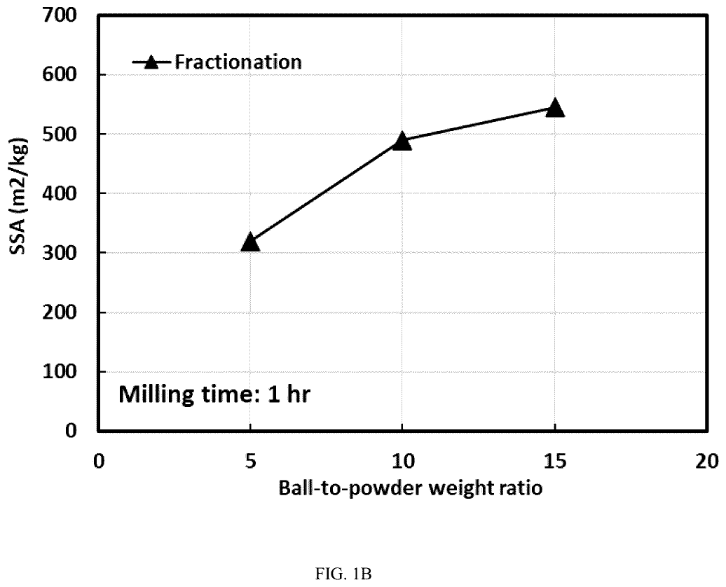

In this example, planetary ball milling was used to subject mineral residues to fractionation treatment. The mineral residues were fractionated using MTI planetary ball mill equipment. The mineral residue was sourced from hydrated lime that was previously used in a flue gas treatment process which used the sorbent injection method. The specific surface area (SSA) of the mineral residue as-is was around 230 m²/kg. The mineral residue was composed of 10 mass % CaCO₃ and 61 mass % Ca(OH)₂ as determined using thermogravimetric analysis (TGA; STA 6000, Perkin Elmer). The specific surface area (SSA, unit of m²/kg) of the mineral residues was calculated using their particle size distributions and factoring in their densities. The particle size distribution (PSD) of the mineral residues was measured using static light scattering (SLS) using a Beckman Coulter LS13-320 particle sizing apparatus fitted with a 750 nm light source. The powder was dispersed into primary particles via ultrasonication in isopropanol (IPA), which was used as the carrier fluid in the SLS measurements. Mineral residues were loaded into a steel jar volume of 0.5 L. The milling media were 1 mm-25 mm diameter steel balls. The milling speed was 200 RPM (revolution per minute). The ball milling parameters such as milling duration and ball-to-powder weight ratio were altered as shown in FIGS. 1A and 1B. The milling duration varied from 0.25 hours to 5 hours, and the ball-to-powder weight ratio varied from 5 to 15. FIG. 1A shows the variation in the specific surface area (SSA) of the mineral residues as a function of milling duration at a constant ball-to-powder ratio of 10. FIG. 1A also shows the effect of milling duration on the specific surface area of the mineral residue. FIG. 1B shows that the SSA of the mineral residues improves and increase after fractionation treatment at varying ball-to-weight ratio. FIG. 1B shows the effect of the ball-to-powder weight ratio on the specific surface area of the fractionated mineral residue.

The results indicate that mineral residues can be fractionated and deagglomerated during milling process. It can be seen that SSA refinement reaches a plateau for certain milling durations depending on the initial degree of agglomeration and particle size of mineral residue.

### Example 2

### Effects of Mechanochemical Activation on Enhancing Surface Areas of Mineral Residues

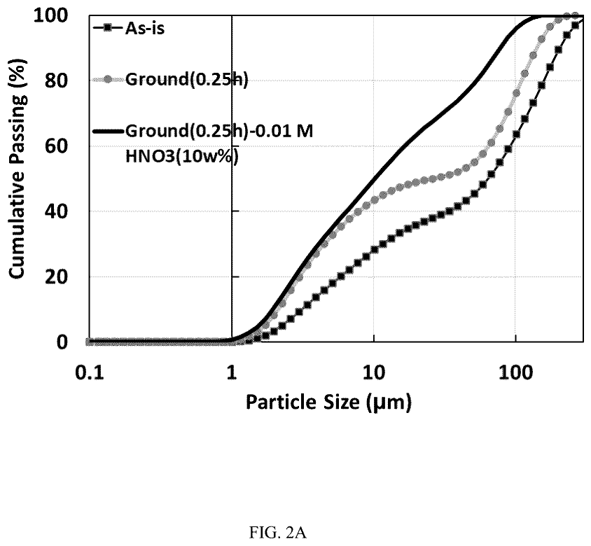

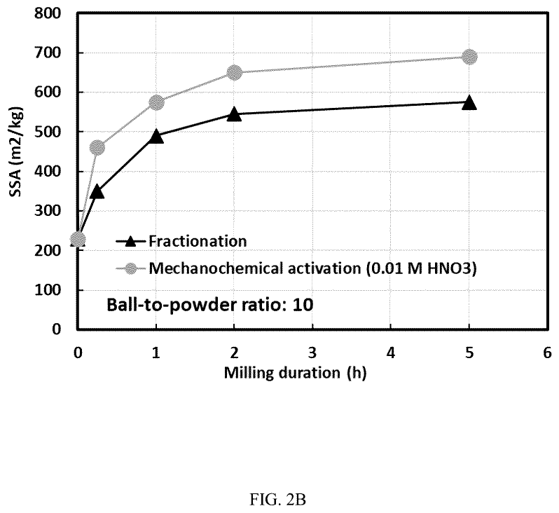

In this example, two treatment methods of fractionation alone and mechanochemical activation (combined fractionation and acid treatment) were compared for the similar mineral residue that was used for example 1. For the mechanochemical method, nitric acid (HNO₃) solution was prepared at concentrations of 0.01 mol/L and sprayed into mineral residues, and then loaded into steel jar of ball milling apparatus for fractionation treatment. FIG. 2A shows the PSD of mineral residues following fractionation and mechanochemical treatments. FIG. 2B compares two treatment methods as a function of milling duration at a fixed ball-to-powder weight ratio of 10. The results indicate that mechanochemical treatment is more efficient than fractionation alone for increasing the SSA of mineral residues. This can be due to the combined effect of dissolution of carbonate layer (CaCO₃) and grinding aid potential (lubrication effect). This results in a greater fineness and deagglomeration at an equivalent ball milling energy process. The PSD plot may also indicate that a CaCO₃ layer is being removed by the mechanochemical process and that the larger particles became finer.

FIG. 2A shows the particle size distribution of mineral residues that are subjected to treatment as determined using static light scattering. FIG. 2B shows a comparison of fractionation and mechanochemical activations with regard to increasing the specific surface area of the mineral residue. Two treatment methods of fractionation and mechanochemical activation were used. For the mechanochemical method, nitric acid (HNO₃) solution was prepared at concentrations of 0.01 mol/L. The nitric acid solution dosage was fixed at 10 mass % of residue.

### Example 3

### Effects of Fractionation and Mechanochemical Treatments on Removing Passivation Layer and Exposing Residual Ca(OH)₂ of Mineral Residues

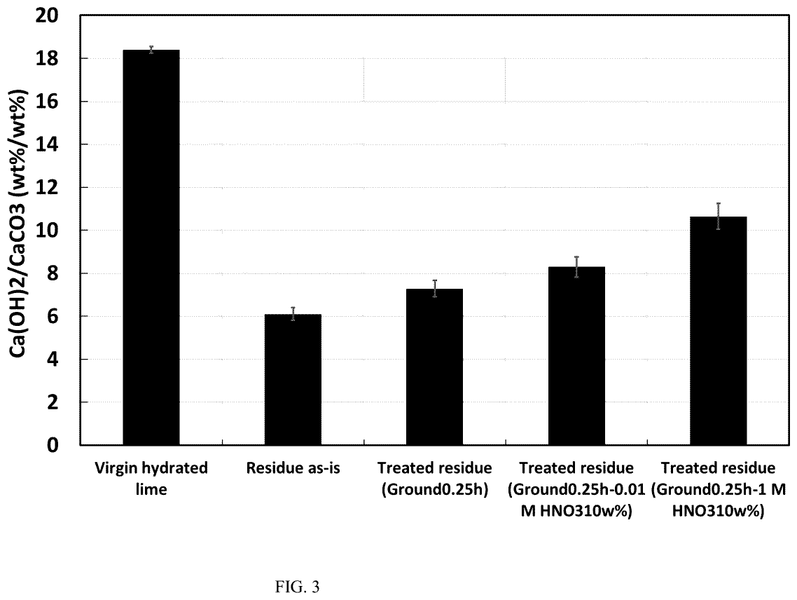

Thermogravimetric analysis (TGA; STA 6000, Perkin Elmer) will be used to assess the extent of carbonation (i.e., conversion amount) experienced by the powder reactants and monoliths. Around 40 mg of powder will be heated from 35° C. to 975° C. at 15° C./min in an aluminum oxide crucible, under a 20 mL/min ultra-high purity N2 purge. The Ca(OH)₂ and CaCO₃ contents were quantified by assessing the mass loss associated with Ca(OH)₂ dihydroxylation and CaCO₃ decomposition over the temperature range from 300° C. to 550° C. for Ca(OH) 2 and from 550° C. to 950° C. for CaCO₃. The mineral residues used in the previous examples and subjected to treatment were analyzed using TGA to quantify the effect of treatment on removing carbonate layer and exposing residual Ca(OH)₂ of mineral residues due to fractionation and acid treatment. For the mechanochemical method, nitric acid (HNO₃) solution was prepared at concentrations of 0.01 and 1 mol/L. The nitric acid solution dosage was fixed at 10 mass % of residue. Fractionation time (milling duration) was set at 0.25 hours. FIG. 3 indicates the effects of treatment on Ca(OH)₂/CaCO₃ ratio of mineral residues. For comparison, the Ca(OH)₂/CaCO₃ ratio of virgin hydrated lime is also presented. Mechanochemical treatment resulted in a greater Ca(OH)₂/CaCO₃ ratio due to both the dissolution of the carbonate layer (CaCO₃) on surfaces of residues and due to increasing the accessibility of Ca(OH)₂ in residue. This shows an increase in the available amount of Ca(OH) after the mechanochemical method.

FIG. 3 shows the effects of the treatment processes for exposing residual Ca(OH)₂ and removing the passivating carbonate layer from the mineral residues. Two treatment methods of fractionation and mechanochemical activation were used. For the mechanochemical method, nitric acid (HNO₃) solution was prepared at concentrations of 0.01 and 1 mol/L. The nitric acid solution dosage was fixed at 10 mass % of residue. Fractionation time (milling duration) was set at 0.25 hours. To provide a point of reference, both untreated mineral residue as-is and virgin minerals are provided. All data reported herein are the average of three replicate measurements.

### Example 4

### Effects of Fractionation and Mechanochemical Treatments on Carbonation Behavior of Reactivated Mineral Residues

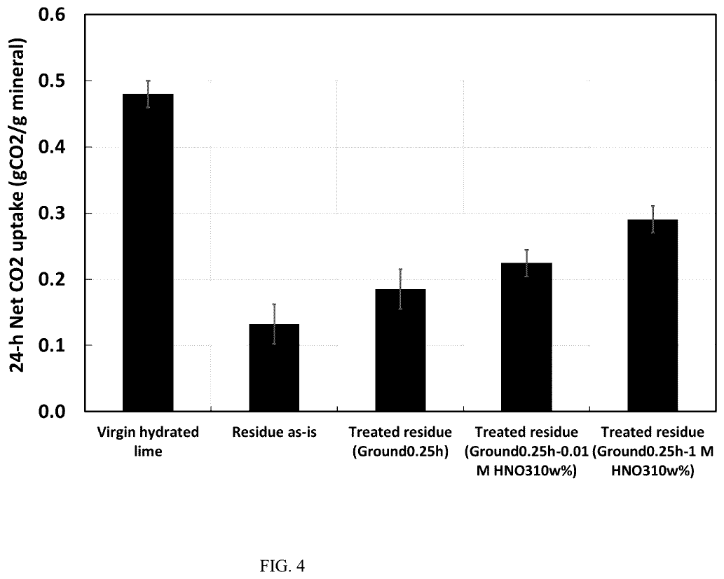

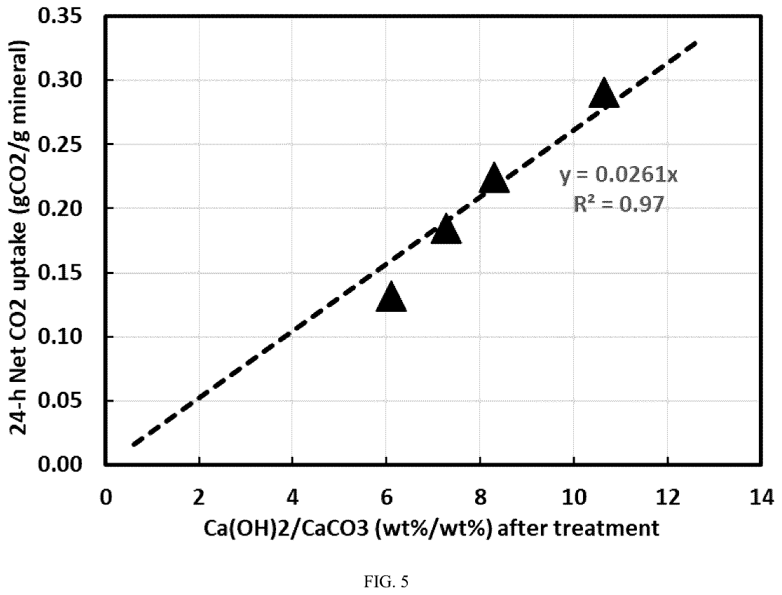

A flow-through reactor was used to expose the mineral residues (treated and untreated) to CO₂ gas streams. The cylindrical reactors feature an internal diameter of 100 mm and a length of 170 mm. The cylinders were sealed with threaded endcaps with 6.4 mm diameter inlets and outlets located centrally to create flow along the cylinder's axis. The reactors are housed horizontally in a digitally controlled oven (Quincy Lab, Inc.) for temperature control. The RH and T were monitored within each reactor (HX71V-A, Omega; Type T thermocouples, respectively) with a data acquisition system (cDAQ-9178, National Instruments; LabVIEW 2014). Dry gas mixtures with varying CO₂ concentrations were prepared by mixing air and CO₂ at prescribed flow rates using mass flow controllers (Alicat), providing an inlet flow rate of 2 slpm (standard liter per minute) of dry gas per reactor. The dry gas mixtures were humidified by bubbling through gas washing bottles housed in a separate oven, the temperature of which was controlled to achieve the desired RH within the feed gas stream. In all cases, the gas stream featured [CO₂]=12%, T=50° C., RH=80%, and 2 slpm flow rate. Thermogravimetric analysis (TGA; STA 6000, Perkin Elmer) was used to assess the extent of CO₂ uptake experienced by the residues. Around 40 mg of powder will be heated from 35° C. to 975° C. at 15° C./min in an aluminum oxide crucible, under a 20 mL/min ultra-high purity N2 purge. The CO₂ content of the solid was quantified by assessing the mass loss associated with CaCO₃ decomposition over the temperature range from 550° C. to 900° C., normalized by the mass of the initially dry powder reactant. It should be noted that the net CO₂ uptake accounted for the initial quantity of carbonates that were present in the reside minerals after treatment and prior to the carbonation process. FIG. 4 shows the 24-h net CO₂ uptake of mineral residues. For comparison, the CO₂ uptake of virgin hydrated lime is also indicated. Due to a greater Ca(OH)₂/CaCO₃ ratio, reactivated mineral residues prepared via mechanochemical activation process featured a greater CO₂ uptake than those treated with only fractionation. The newly exposed surface areas increased the gas-solid interfaces and enhanced the carbonation reaction when a CO₂-containing gas stream was passed through the reactor. FIG. 5 highlights the relationship between Ca(OH)₂/CaCO₃ ratio of the mineral sorbent residue and the CO₂ uptake following exposure to CO₂-containing gas stream.

FIG. 4 shows the effects of the treatment processes on CO₂ uptake of mineral residues following 24-h exposure CO₂ (v/v) gas stream. In all cases, the gas stream featured [CO₂]=12%, T=50° C., RH=80%, and 2 slpm flow rate. Two treatment methods of fractionation and mechanochemical activation were used. For the mechanochemical method, nitric acid (HNO₃) solution was prepared at concentrations of 0.01 and 1 mol/L. The nitric acid solution dosage was fixed at 10 mass % of residue. Fractionation time (milling duration) was set at 0.25 hours. To provide a point of reference, both untreated mineral residue as-is and virgin minerals are provided. It should be noted that the net CO₂ uptake accounted for the initial quantity of carbonates that were present in the reside minerals after treatment and prior to the carbonation process. All data reported herein are the average of three replicate measurements.

FIG. 5 shows the Variation of CO₂ uptake by the mineral sorbent residues as a function of exposed Ca(OH)₂ following the treatment process. In all cases, the gas stream featured [CO₂]=12%, T=50° C., RH=80%, and 2 slpm flow rate. It should be noted that the net CO₂ uptake accounted for the initial quantity of carbonates that were present in the reside minerals after treatment and prior to the carbonation process.

### Example 5

### Effects of Fractionation and Mechanochemical Treatments on Compressive Strength of Carbonated Concrete Composites Made with Reactivated Mineral Residues

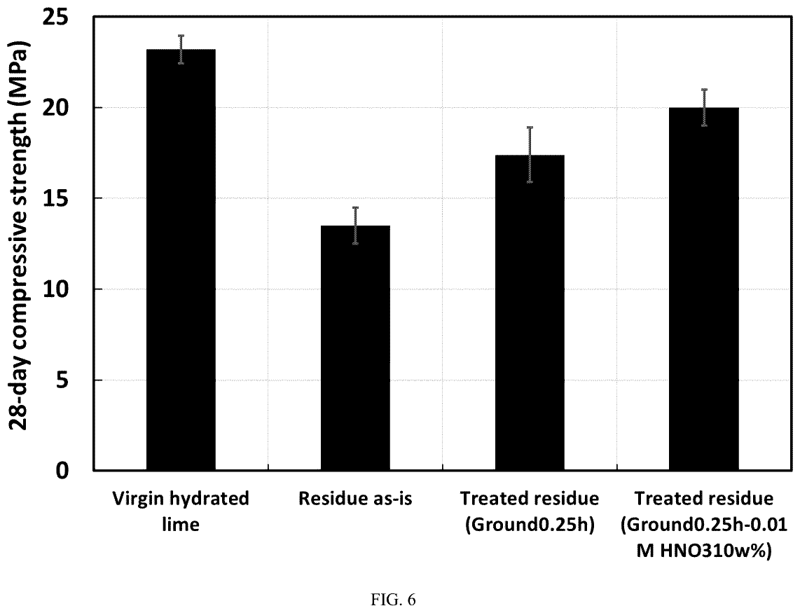

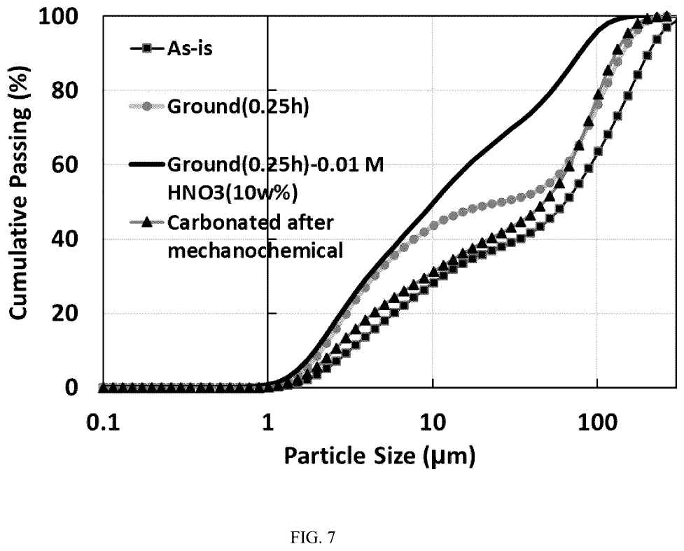

Mineral residues after fractionation and mechanochemical treatments were used to prepare concrete mixtures. For the mechanochemical treatment, HNO₃ solution was prepared at concentrations of 0.01 mol/L. The nitric acid solution dosage was fixed at 10 mass % of residue. Fractionation time (milling duration) was set at 0.25 hours. A mixture of hydrated lime residue, sand, fly ash, and water was used to prepare dry-cast concrete formulation. Dry-cast composites were prepared by compaction using a hydraulic press to form cylindrical specimens (75 mm×60 mm; d×h) and the compaction pressure was set at 10 MPa. The compressive strengths of concrete composites that were composed of reactivated mineral residues and exposed to CO₂ streams for 24 hours were measured at 28 days. To provide a point of reference, similar concrete mixtures incorporating untreated mineral residues and virgin mineral materials were prepared, and their corresponding compressive strengths were measured. FIG. 6 compares the 28-day compressive strengths of concrete mixtures incorporating untreated and treated mineral residues and virgin hydrated lime. Reactivation of mineral residues after treatment improved the compressive strength of the concrete mixtures as a result of both the increased surface area and the increased accessibility of Ca(OH)₂ in the mineral sorbent residues. This results in greater amounts of precipitated calcium carbonate over the course of carbonation curing. Calcium carbonate precipitation can refine porosity and densify microstructure thus enhancing compressive strength. FIG. 7 shows the PSD of mineral residues after treatment and following CO₂ exposure. The PSD of mineral residue after carbonation increased due to the precipitated calcium carbonates on the surface of the reactivated mineral residue.

FIG. 6 shows the 28-day compressive strength of carbonated concretes made with treated and untreated mineral residues following 24-h exposure to 12% CO₂ (v/v) gas stream at 50° C. Following carbonation curing, concrete samples were sealed until testing age at 28 days. Two treatment methods of fractionation and mechanochemical activation were used. For the mechanochemical method, nitric acid (HNO₃) solution was prepared at concentrations of 0.01 mol/L. The nitric acid solution dosage was fixed at 10 mass % of residue. Fractionation time (milling duration) was set at 0.25 hours. The residue (hydrated lime residue) dosage was fixed at 4 mass % of total solid in concrete formulation. To provide a point of reference, both untreated mineral residue as-is and virgin minerals are provided. All strength data reported herein are the average of three replicate specimens cast from the same mixing batch.

FIG. 7 shows the alteration of particle sizes of mineral residue before and after treatment and following 24-h exposure to 12% CO₂ (v/v) gas stream at 50° C. Two treatment methods of fractionation and mechanochemical activation were used. For the mechanochemical method, nitric acid (HNO₃) solution was prepared at concentrations of 0.01 mol/L. Fractionation time (milling duration) was set at 0.25 hours. The nitric acid solution dosage was fixed at 10 mass % of total solid.

The embodiments and examples described above are intended to be merely illustrative and non-limiting. Those skilled in the art will recognize or will be able to ascertain using no more than routine experimentation, numerous equivalents of specific compounds, materials, process, and procedures. All such equivalents are considered to be within the scope and are encompassed by the appended claims. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure. It should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto.

1. A process for re-activating a mineral residue, comprising:
providing a mineral residue, wherein the mineral residue comprises a core and a shell around the core;
wherein the core comprises a hydroxide or oxide of calcium (Ca), magnesium (Mg), or combinations thereof and wherein the shell comprises a member selected from the group consisting of an oxide, a hydroxide, a carbonate, a silicate, a sulfite, a sulfate, a chloride, a nitrate, or nitrite, of Ca or of magnesium (Mg), and a combination thereof; and either:
(a) fractionating the mineral residue;
(b) contacting the mineral residue with an acid and fractionating the mineral residue; or
(c) contacting the mineral residue with a base and fractionating the mineral residue;
to provide reactivated mineral material;
wherein fractionating the mineral residue comprises grinding the mineral residue or milling the mineral residue; and
wherein the core is exposed after steps (a), (b), or (c).

2. The process of claim 1, wherein the mineral residue comprises CaO, Ca(OH)₂, or a combination thereof.

3. The process of claim 1 wherein the core comprises CaO, Ca(OH)₂, or a combination thereof.

4. The process of claim 1, wherein the shell comprises a carbonate of Ca, a carbonate of Mg, or a combination thereof.

5. (canceled)

6. The process of claim 1, wherein the mineral residue is a mineral sorbent residue obtained by contacting a mineral residue with a flue gas.

7. (canceled)

8. The process of claim 1, wherein the mineral residue is obtained from hydrated lime that was previously used in a flue gas treatment process which used the sorbent injection method.

9. The process of claim 1, wherein the mineral residue is an alkaline-rich mineral material which has been already contacted with a CO₂-containing gas stream.

10. The process of claim 1, wherein the mineral residue is selected from the group consisting of hydrated lime, lime kiln dust, cement kiln dust, fly ash, limestone, and combinations thereof.

11.-14. (canceled)

15. The process of claim 1, wherein the reactivated mineral material has a higher specific surface-area after step (a), (b), or (c), than the mineral residue.

16.-19. (canceled)

20. The process of claim 1, wherein the reactivated mineral material has a specific surface-area of 230 m²/kg or more after step (a), (b), or (c).

21. (canceled)

22. The process of claim 1, wherein step (a) comprises fractionating the mineral residue if the amount of carbonate in the mineral residue is fifty percent or less by weight of the mineral residue.

23. The process of claim 1, wherein the ratio of Ca(OH)₂/CaCO₃ in the mineral residue increases after step (a), (b), or (c).

24.-28. (canceled)

29. The process of claim 1, wherein the ratio of Ca(OH)₂/CaSO₄ in the mineral residue increases after step (a), (b), or (c).

30.-32. (canceled)

33. The process of claim 1, comprising either (b) contacting the mineral residue with an acid and fractionating the mineral residue, if the amount of carbonate in the mineral residue is fifty percent or more by weight of the mineral residue; or (c) contacting the mineral residue with a base and fractionating the mineral residue, if the amount of carbonate in the mineral residue is fifty percent or more by weight of the mineral residue.

34.-42. (canceled)

43. The process of claim 1, wherein the fractionating the mineral residue comprises at least one of dry grinding, semi-wet grinding, or wet grinding.

44. The process of claim 1, wherein the acid is selected from the group consisting of sulfuric acid, hydrochloric acid, nitric acid, phosphoric acid, phosphorous acid, acetic acid, phosphonic acid, citric acid, myristic acid, glycolic acid, lactic acid, maleic acid, malic acid, succinic acid, glutaric acid, benzoic acid, malonic acid, salicylic acid, gluconic acid, muriatic acid, trifluoroacetic acid, carbonic acid, and combinations thereof.

45.-50. (canceled)

51. The process of claim 1, wherein the base is select from the group consisting of sodium hydroxide, potassium hydroxide, lithium hydroxide, calcium hydroxide, magnesium hydroxide, ammonium hydroxide, sodium carbonate, sodium bicarbonate, ammonia, methylamine, dimethylamine, trimethylamine, triethylamine, monoethanolamine, diethanolamine, triethanolamine, isopropanolamine, diisopropanolamine, triisopropanolamine, alkali metal silicates, alkaline earth metal silicates, and combinations thereof.

52.-61. (canceled)

62. A process for forming a concrete component comprising:
forming a cementitious slurry comprising aggregates and mineral residue that has previously been subjected to a process of claim 1;
shaping the cementitious slurry into a structural component; and
exposing the structural component to CO₂-containing gas sourced from a dilute flue gas stream, a concentrated CO₂ stream, or from the atmosphere, thereby forming the concrete component.

63.-70. (canceled)
